(19) United States
(12) Patent Application Publication
(10) Pub. No.: US 2012/0050855 A1
(43) Pub. Date: Mar. 1, 2012

(54) ADAPTER DISK

(76) Inventors: Gabriela Cochius, Diessen am Ammersee (DE); Bernhard Moser, Hargelsberg (AT)

(21) Appl. No.: 13/255,283

(22) PCT Filed: Mar. 10, 2010
(86) PCT No.: PCT/AT10/00072

§ 371 Date: Nov. 16, 2011

(30) Foreign Application Priority Data
Mar. 10, 2009 (AT) A 386/2009

(51) Int. Cl. G02B 27/22; G02B 5/22

(52) U.S. Cl. 359/462; 359/885

(57) ABSTRACT

A device for fixing an adapter unit (1) comprising an optical film (16) and/or an optical plate to a monitor (4) consisting of a display (7) and a frame (4), said device (11) comprising a first means by which the adapter unit is spaced apart from the display (7) by a defined distance by means of a defined first force (3, 3′) which is substantially directed from the adapter unit (1) towards the monitor (7).

A device for fixing an optical adapter unit comprising an optical film and/or an optical plate to a monitor consisting of a display and a monitor frame.

Known detachable devices for fixing optical adapter units, such as filters and surface protection films, to a monitor usually consist of socket or screw joints, which have the disadvantage that an exact spacing apart of the optical adapter unit and the monitor is not possible. The application of said device is thus restricted to being used with optical adapter units which can be used without requiring an exact spacing apart from the monitor.

Optical adapter units, such as a stereoscopic adapter unit, require an exact spacing apart from the display. The adapter unit should further be detachable from the monitor, as a stereoscopic adapter unit, for example, would be disturbing, if the monitor was used without pseudo holographic effects.

The task of the invention discussed herein is to provide a device for attaching an optical adapter unit to a monitor in an easy-to-handle, precise, and reproducible way. Moreover, the display's different positions in depth in relation to the monitor frame are to be compensated by an easy-to-handle fixing device. According to the present invention, this task is fulfilled by providing the device with a first means by which, by means of a first force which is substantially directed from the adapter unit towards the monitor, a defined distance is established between the adapter unit and the monitor. In the framework of the invention discussed herein, the optical film may, for example, be stretched on a frame which is part of the device of the invention. It is also possible that the film is fixed to a support plate or is stretched on the device of the invention for attaching the optical adapter unit.

In a preferred embodiment, the optical adapter unit has a multi-layer structure. Apart from the at least one layer which is responsible for the optical effect of the adapter unit, further layers, which, for example, may have a protective or thermoinsulating function or may serve as support plates, may be included.

The device of the invention may also comprise a second means creating a defined second force which is substantially directed against the direction of the first force so that an equilibrium of forces is established between said first force and said second force. The display's position in depth in relation to the surface of the monitor frame, which is approximately parallel to the display, may vary strongly in different monitor types making the fixing or the ideal positioning of the adapter unit by means of devices according to the prior art impossible. By using the first and/or second means and by means of the thus created first and second forces, the above mentioned position in depth may be compensated. By applying, according to the invention, a first force pressing the optical adapter unit towards the display and a second force acting against the first force, the position of the adapter unit in relation to the display may be continuously calibrated. Thus any changes of the adapter unit and/or the fixing device and/or the monitor may be compensated. Said changes may, for example, be caused by the warming of the monitor, the adapter unit, or the device for fixing the adapter unit, whereby said warming may be due to operation or solar radiation. The adapter unit is positioned by means of the first and second forces depending on the optical effect (e.g. pseudo holographic imaging) produced by the optical film and/or the optical plate. The adapter unit further has to be positioned in a way that ensures that the focal point effect caused by the optics of the adapter unit is not produced in the area of the monitor or of the adapter unit. This way, an excessive warming, which could cause the melting or inflammation of certain elements, may be prevented. The combination of the first and second means for fixing the adapter unit may further have the function to prevent damage caused to the adapter unit and/or the monitor by a user in the course of attaching said adapter unit in an unskilled way.

The device according to the invention may position the adapter unit in such a way that there is no space between said adapter unit and the display.

The device according to the invention may also be formed in a way in which said device comprises a magnet as the first means for applying the first force as well as a counterpart and/or an adhesive. The use of a magnet for applying the first force makes a quick and easy fixing of the adapter unit to the monitor possible. The adapter unit may also be easily removed again, as the user does not have to detach any fixing means. The magnetic force required for fixing the adapter unit may easily be overcome by the user. Due to the effect of the magnet's force, it is possible for a user to attach the adapter unit without having to apply force himself.

The specification of the present invention does not exclude that the device of the invention is designed in a way in which said device comprises a fixing device, such as a screw, and/or a clamping device as the first means for applying the first force. Apart from that, all other arrangements which make it possible to apply a first force according to the above description and which are known to those skilled in the art may be used. One possible embodiment of the device according to the invention consists of a slot into which the adapter unit may be introduced from one side and is fixed by means of a clamping device, such as by means of the slot being tapered.

The device according to the invention may, in one embodiment, comprise an elastic element, such as a spring, as the second means for applying the second force. A combination of a magnet and its counterpart with a spring makes it possible to compensate the display's different positions in depth in relation to the frame surface, said positions in depth varying in different types of monitors. By means of the spring, the magnet may be displaced in relation to its counterpart by its own magnetic effect so that the display's different positions in depth in relation to the monitor frame may be compensated.

The device according to the invention may be practiced in a way in which said device comprises a first means for applying a first force and/or a second means for applying a second force, said first means and/or said second means directing said first force and/or said second force in such a way that one component of said first force and/or of said second force is oriented within the same plane as the adapter unit.

In case optical films are used, it may be necessary to stretch said films in front of or on the monitor's display.

The device of the invention may comprise guiding means, which are preferably fixed to the monitor's frame. When the device according to the invention is attached for the first time, the adapter unit is at first manually positioned along a reference edge, for example along the display's lower edge, and then positioned in front of the display. The device of the invention and the guiding elements are pressed against the monitor frame. The guiding elements may comprise a double faced adhesive tape so that they can be easily attached to the monitor frame. By using guiding means, such as pins, the adapter unit may be positioned in relation to the monitor, especially at a level parallel to the monitor's display. The guiding means may be designed in such a way that they define the directions of the first force and of the second force.

The device of the invention may comprise guiding means which allow for a movement of the adapter unit parallel to the level of the display, said movement being caused, for example, by the thermal expansion of the adapter unit. The warming and the consequent expansion of the adapter unit may be caused by the warming of the monitor during operation or by insolation.

The device of the invention may be a fixing device for an optical film and/or an optical plate which represent at least one part of a stereoscopic adapter unit and/or a touch screen. The adapter unit may consist of several layers, for example an insulating layer, an optical film or an optical plate, and a support plate. The support plate may have flaps at its edges so that it is possible for the user to easily remove and attach the insulating layer and the optical film or the optical layer. By means of said flaps, the layers of the adapter unit are held together. The invention discussed herein is not limited to the layers being rigidly connected with each other. The support plate may be constructed in any form known to those skilled in the art which enables the layers to be easily attached and removed. In most cases, the insulating layer is disposed on the side facing the user. On the one hand, this layer fulfils the function of protecting the optical film or the optical plate. On the other hand, it protects the optical film or the optical layer from excessive warming caused by insolation or other sources of light.

The device of the invention may be designed in such a way that it comprises means for positioning the adapter unit in a first position in which pseudo holographic effects of the adapter unit are at least partially perceptible to the viewer and/or in a second position in which said pseudo holographic effects of the adapter unit are not perceptible to the viewer. The means for positioning the adapter unit may, for example, allow moving the adapter unit in a parallel and/or perpendicular direction in relation to the level of the monitor. Within the frame of the present invention it is not excluded either that the adapter plate is tilted in relation to the monitor level.

The invention discussed herein also refers to a procedure for calibrating the distance between the monitor and an adapter unit consisting of an optical film and/or an optical plate, whereby said adapter unit is spaced apart from the monitor by means of a first predefined force which is substantially directed from the adapter unit towards the monitor.

The procedure of the present invention may be complemented by spacing the adapter unit apart from the monitor by means of a predefined second force which is substantially directed from the monitor towards the adapter unit, whereby an equilibrium of forces is established between said first force and said second force.

A possible way of calibrating the distance between the adapter unit and the display may consist in positioning the adapter unit in relation to the monitor in such a way that there is no space between the adapter unit and the display.

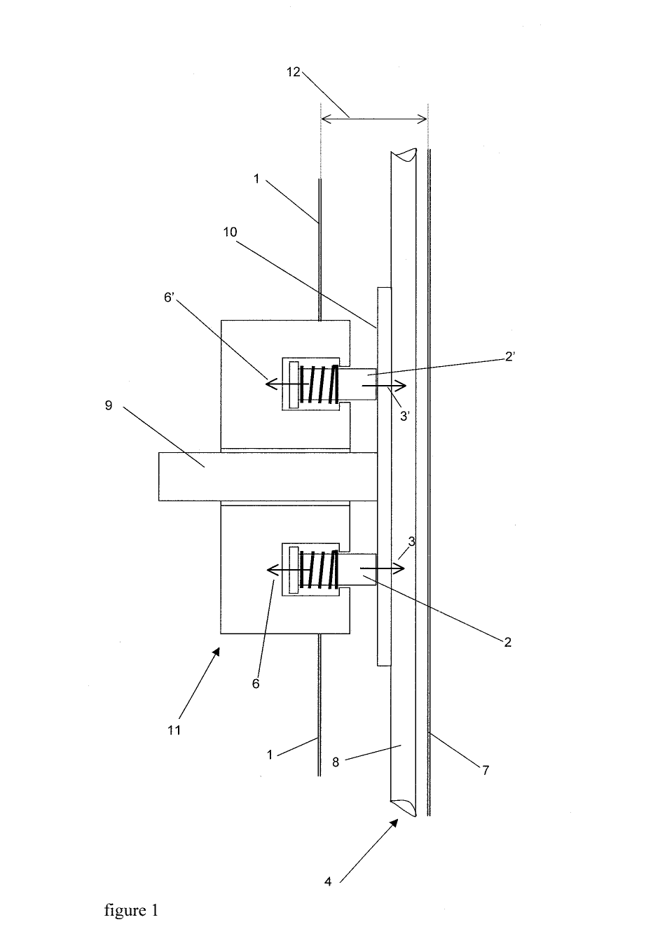

FIG. 1 shows a vertical cross-sectional view of an exemplary embodiment of the device of the present invention.

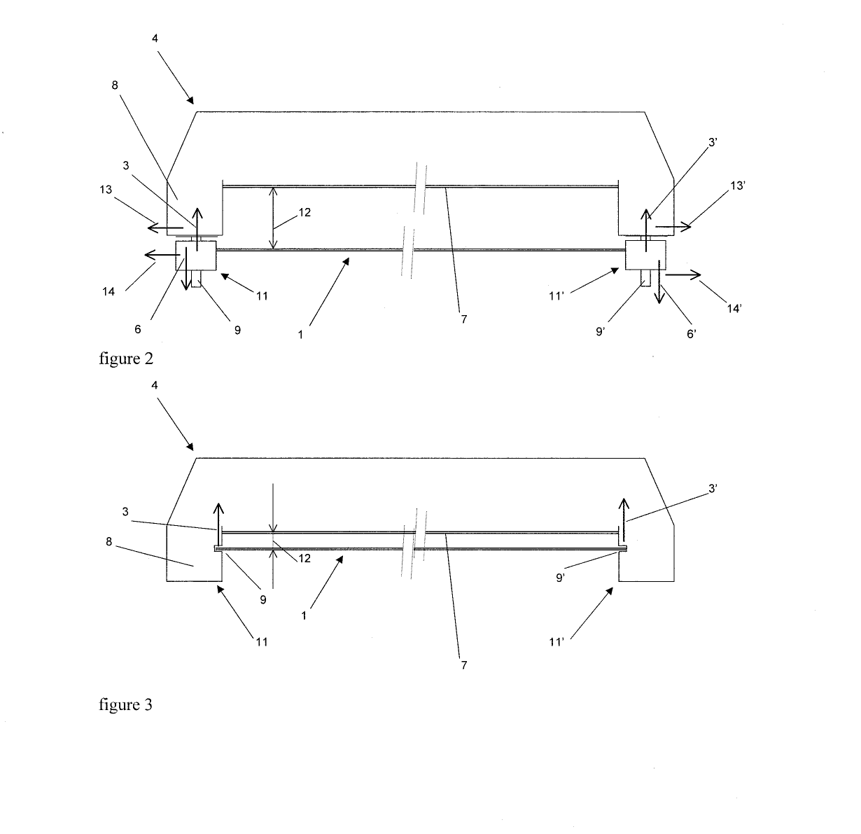

FIG. 2 shows a horizontal cross-sectional view of the embodiment of the device of the present invention shown in FIG. 1.

FIG. 3 shows a horizontal cross-sectional view of another exemplary embodiment of the device of the present invention.

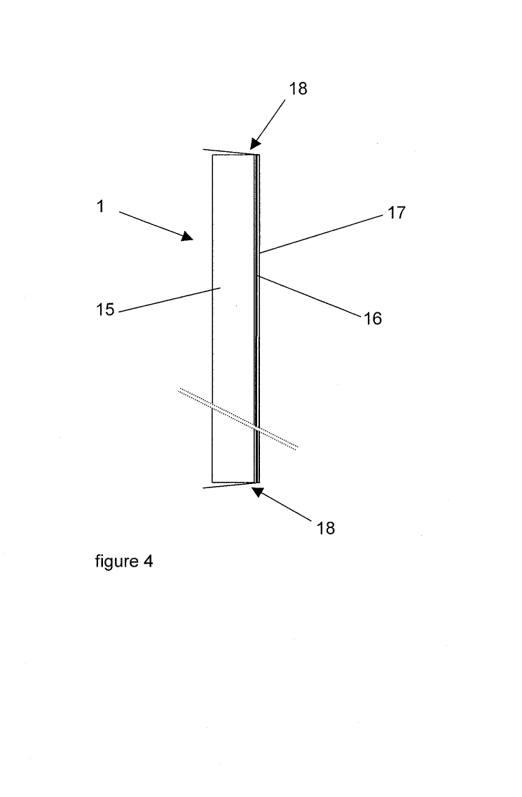

FIG. 4 shows a vertical cross-sectional view exactly corresponding to the horizontal cross-sectional view of an adapter plate which can be fixed to a monitor by means of the device of the present invention.

FIG. 1 shows a vertical cross-sectional view of an exemplary embodiment of the device 11 of the present invention, said device 11 comprising magnets 2, 2′ and a counterpart 10 as the first means which establishes a predefined distance between an adapter unit 1 and the display 7 by means of a predefined first force 3, 3′, which is substantially directed towards the monitor 4. Said device 11 further comprises springs 5, 5′ as the second means creating a second force 6, 6′, which is substantially directed against the direction of said first force 3, 3′, so that an equilibrium of forces is established between said first force 3, 3′ and said second force 6, 6′. By means of said equilibrium of forces, the distance between the adapter unit 1 and the monitor 4, especially the display 7 of the monitor 4, may be adjusted. A guiding element 9 which allows for the positioning of the adapter unit 1 at a level parallel to the display 7 of the monitor 4 is fixed to the frame 8 of the monitor 4. In the embodiment shown in FIG. 1, the counterpart 10 to the magnets 2, 2′ is integrally formed with said guiding element 9. The guiding element 9 as well as the magnets 2, 2′, the counterpart 10, and the springs 5, 5′ are disposed in such a way that it is possible for the adapter unit 1 to expand, which may be due to the warming of the adapter unit 1. The device 11 is connected to the adapter unit in a force-fitted way. The adapter unit 1 may be a unit for the autostereoscopic and pseudo holographic reproduction of an image displayed on the display 7 of the monitor 4. The image may also be part of a film (moving image). The adapter unit 1 consists either of at least one film or of a plate.

FIG. 2 shows a horizontal cross-sectional view of the exemplary embodiment shown in FIG. 1, wherein by means of the first forces 3, 3′ corresponding forces 13, 13′ and/or by means of the second forces 6, 6′ corresponding forces 14, 14′ are created. This is achieved by disposing the guiding elements 9, 9′ in an inclined position. The forces 13, 13′ and/or the forces 14, 14′ lead to a stretching of the film-like adapter unit 1.

FIG. 3 shows a horizontal cross-sectional view of another exemplary embodiment of the device 11 according to the present invention, wherein the guiding elements 9, 9′ are integrated into the frame 8 of the monitor 4. The first forces 3, 3′ are created by means of the guiding elements 9, 9′ being tapered.

FIG. 4 shows a vertical cross-sectional view exactly corresponding to the horizontal cross-sectional view of an adapter unit 1 which may be attached to a monitor 4 by means of the device 11 of the present invention. Said adapter unit 1 has a multi-layer structure consisting of an insulating layer 15, an optical film 16 or an optical plate, and a support plate 17. The support plate 17 has an edge with flaps 18 which press the insulating layer 15 and the optical film 16 or the optical plate onto the support plate. Due to this structure of the support plate, the insulating layer 15 and the optical film 16 may easily be exchanged.

The lenticular grid of the optical film 15 or the optical plate may be slanted (at an angle of approximately 11.0° within the same plane as the optical foil 16 or the optical plate).

1. A device (11) for fixing an optical adapter unit (1) consisting of an optical film (16) and/or an optical plate to a monitor (4) consisting of a display (7) and a frame (8), characterised in that said device (11) comprises a first means by which said adapter unit (1) is spaced apart from the display (7) by a defined distance (12) by means of a defined first force (3, 3′) which is substantially directed from the adapter unit (1) towards the monitor (4).

2. The device (11) according to claim 1, characterised in that said device (11) comprises a second means creating a defined second force (6, 6′) which is substantially directed against the direction of said first force (3, 3′), so that an equilibrium of forces is established between said first force (3, 3′) and said second force (6, 6′).

3. The device (11) according to claim 1 or claim 2, characterised in that there is no space (12) between the adapter unit (1) and the display (7).

4. The device (11) according to any one of the claims 1 to 3, characterised in that said device (11) comprises a magnet (2, 2′) and its counterpart and/or an adhesive as said first means for applying said first force (3, 3′).

5. The device (11) according to any one of the claims 1 to 4, characterised in that said device (11) comprises a fixing device, such as a screw, and/or a clamping device, as said first means for applying said first force.

6. The device (11) according to any one of the claims 1 to 5, characterised in that said device (11) comprises an elastic element, such as a spring (5, 5′), as said second means for applying said second force.

7. The device (11) according to any one of the claims 1 to 6, characterised in that said device comprises a first means for applying a first force (3, 3′) and/or a second means for applying a second force (6, 6′), said first means and/or said second means directing said first force (3, 3′) and/or said second force (6, 6′) in such a way that one component of the first force (3, 3′) and/or of the second force (6, 6′) is oriented within the same plane as the adapter unit (1).

8. The device (11) according to any one of the claims 1 to 7, characterised in that said device (11) comprises guiding means (9), which are preferably attached to the frame (8) of the monitor (4).

9. The device (11) according to any one of the claims 1 to 8, characterised in that said device (11) comprises guiding means (9) which allow that the adapter unit (1) moves at a level parallel to the. level of the display (7), said movement being caused, for example, by the thermal expansion of said adapter unit (1).

10. The device (11) according to any one of the claims 1 to 9, characterised in that the optical foil (16) and/or the optical plate are at least one part of a stereoscopic adapter unit (1) and/or of a touch screen.

11. The device (11) according to any one of the claims 1 to 20, characterised in that said device (11) comprises means for positioning the adapter unit (1) in a first position in which pseudo holographic effects of the adapter unit (1) are at least partly perceptible to the viewer and/or in a second position in which said pseudo holographic effects of the adapter unit (1) are not perceptible to the viewer.

12. A procedure for calibrating the space (12) between an adapter unit (1) consisting of an optical film (16) and/or an optical plate, characterised in that the adapter unit (1) is spaced apart form the monitor (4) by means of a predefined first force (3, 3′) which is substantially directed from the adapter unit (1) towards the monitor (4).

13. The procedure according to claim 12, characterised in that the adapter unit (1) is spaced apart from the monitor (4) by means of a predefined second force (6, 6′) which is substantially directed from the monitor (4) towards the adapter unit (1), wherein an equilibrium of forces is established between said first force (3, 3′) and said second force (6, 6′).

14. The procedure according to the claims 12 and 13, characterised in that the adapter unit (1) is positioned in relation to the monitor (4) in such a way that there is no space (12) between said adapter unit (1) and the display (7).
